(19) United States
(12) Patent Application Publication
(10) Pub. No.: US 2006/0168573 A1
(43) Pub. Date: Jul. 27, 2006

(54) Method and apparatus for building an electronic product

(76) Inventors: William Allan Clark, Leyton (GB); Peter Truman, Birmingham (GB)

Correspondence Address: MOTOROLA INC, 600 NORTH US HIGHWAY 45, ROOM AS437, LIBERTYVILLE, IL, 60048-5343, US

(21) Appl. No.: 11/331,804

(22) Filed: Jan. 13, 2006

(30) Foreign Application Priority Data
Jan. 15, 2005 (GB) GB0500648.1

(51) Int. Cl. G06F 9/45; G06F 9/44

(52) U.S. Cl. 717/140; 717/162

(57) ABSTRACT

A method of customising a build of an electronic software-based product comprises the steps of representing in software a plurality of embedded software elements; generating an image that represents a number of embedded software elements; and building a software-based product based on the generated images.

### FIELD OF THE INVENTION

The present invention relates to a method and apparatus for manufacturing a software-based product. The invention is applicable to, but not limited to, building at least partially an electronic product, such as a mobile phone.

### BACKGROUND OF THE INVENTION

Manufacturing processes, including product assembly or product configuration, typically comprise the basic steps of:
(i) Receiving an order for a quantity of the product;
(ii) Allocating the materials required for the manufacture of the product for that order; and
(iii) Assigning the order to one or more manufacturing/assembly/configuration lines.

In order for such processes to be efficient, both in terms of time and cost, numerous factors have to be taken into consideration. Such factors may include, by way of example:
(i) Changes to the product and/or materials of the product;
(ii) Non-dedicated manufacturing and/or assembly and/or configuration lines, i.e. where a line may be used for various different products, and therefore requires adapting each time the product being manufactured/assembled/configured is changed; and
(iii) Personnel involved in the process.

In the field of personal computers, Dell™ provide a web-based tool to enable customers to choose from a short menu that list ‘large’ scale (macro) components in order to customize a product being purchased. The components are self contained applications (together with one or two hardware units, such as a keypad and mouse, that are ‘packaged’ together and shipped in a black-box manner.

In the field of mobile phone technology, a design concept under-pinning mobile phones designed by Sendo™ is for easy configurability in order to facilitate the Sendo business model of building products that are customised to the requirements of network Operators and end-users. A Sendo handset is therefore required, by design, to be as configurable as is possible.

Mobile phone handsets have recently been designed to function more as mini, portable computers, incorporating their own operating system (OS). Primarily for reasons of reliability, as well as customer familiarity, the new generation of mobile phone handsets, termed ‘Smartphones’, incorporate tried and tested OSs.

However, this known prior art has the disadvantage(s) that unfortunately, these OSs have not been developed with “configurability” in mind. Indeed, in contrast, the OSs have been developed to provide as little configurability as possible to ensure consistent performance across all phone platforms. Thus, there are typically many separate and distinct components of the phone platform, and between them there is little consistency or unified design in the context of the OS functionality.

The inventors of the present invention have recognized and appreciated that a radical configuration solution requires configurable elements (software and hardware) to be represented as individual building blocks with minimal interaction between the blocks. Such a building block approach is intuitive and somewhat standardized in a hardware environment. That is, manufacturers effectively already construct a phone from parts, where parts go into subassemblies and subassemblies are combined with parts and other subassemblies to form a complete phone. However, the Lego™ building block approach is only limited to a few mechanical parts of a mobile phone, such as housings, batteries, antenna, etc. These parts, however, are not offered for customisation or configurability.

Accordingly, it would be advantageous to have an improved system for manufacturing and preferably a system having improved flexibility, improved optimisation, reduced cost, reduced associated workload that facilitates greater configurability and customisation.

### BRIEF DESCRIPTION OF THE DRAWINGS

Exemplary embodiments of the present invention will now be described, by way of example only, with reference to the accompanying drawings, in which:

FIG. 1 illustrates an example of a manufacturing system adapted to support the inventive concepts of the preferred embodiments of the present invention; and

FIG. 2 illustrates a schematic functional block diagram and flowchart of a process for a software build of an electronic product in accordance with a preferred embodiment of the present invention.

### DESCRIPTION OF PREFERRED EMBODIMENTS

Statement of Invention

In accordance with a first aspect of the present invention, there is provided a method of customising a build of an electronic software-based product, as claimed in claim 1.

In accordance with a second aspect of the present invention, there is provided a software-based product build system, as claimed in claim 16.

Further aspects and advantageous features of the present invention are as described in the appended Claims.

In summary, the preferred embodiment of the present invention relates to a method of customising a build of an electronic software-based product comprising the steps of representing in software a plurality of embedded software elements; generating an image that represents a number of embedded software elements; and building a software-based product based on the generated images.

Furthermore, a software-based product build system is described that comprises a configurator module arranged to represent in software a plurality of embedded software elements and an image generator, operably coupled to the configurator module and arranged to represent the build environment; and a software-based product build system. The software-based product is able to generate one or more images representing the plurality of embedded software elements and the software-based product build system determines a build of the software-based product in response to the generated images.

The provision of embedded software elements that are configured to define a wide variety of software variants of an electronic product, enables a customer or consumer to ‘build’ individual (or groups of) products, such as phones, ‘on-the-fly’ using software building blocks.

Preferably, hardware elements are also provided as build-configurable elements, such that the customer or consumer is able to use, software elements representing hardware and embedded software building blocks in a Lego™ kit fashion, for example, to build many electronic products using a template of previous ‘build processes’, i.e. new configurations may be based on old configurations. In this manner, the software representation of embedded software elements and hardware elements associated with a product build, such as a mobile phone, facilitates scalable and extensible build architecture.

Advantageously, the product build can be designed over a suitable medium, such as the Internet, to allow greater freedom to the consumer and customer in selecting the preferred configuration of their product purchase(s).

The device configuration/customisation process uses “building blocks” to represent the hardware and software domains. In particular, in the context of the present invention, embedded software elements of the product are represented as software building blocks. Embedded software elements, in the context of the present invention, comprise software modules where software-based functions of an electronic product, such as a mobile phone, are separated into code and data (i.e. software that is not ‘executed’ by a processor). In particular, the inventive concept configures how the code modules execute in a product being manufactured by changing the data. Thus, a tool is provided that allows configuration to be performed in a well-defined, semi-automated manner. Notably, the configuration is performed safely (i.e. inconsistencies between software modules are avoided). This is advantageous when configuring complex embedded software-based products due to the huge number of product variations that can be ultimately manufactured. Thus, a standardized process of driving down customization throughout the embedded software contained within a product is supported.

A user (including but not limited to consumers, customers, customisation staff, sales staff, etc.) is to be provided with the opportunity to effectively “click” together a working device from preferably a mixture of embedded software and additional hardware components. The embedded software is such that a user “clicks” together a working software domain (hereinafter referred to as “image”) comprising, for example, an OS and/or one or more applications and/or one or more settings and/or one or more resources to fit that phone. It is envisaged that the software build can be configured over the Internet, through a web-based application or by another system, such as a customer's own computer system.

Notably, it is within the contemplation of the present invention that the customization of a software-based electronic product may encompass every aspect of the product, in addition to the embedded software elements.

Thus, in the context of the present invention, it is envisaged that the embedded software may be configured to represent further elements in addition to the software elements, for example representing at least:
(i) One or more hardware elements; and/or
(ii) One or more packaging elements; and/or
(iii) One or more accessories.

As such, it is envisaged that the customization of the software-based electronic product may encompass the box that the product is shipped in, for example, its size, shape, colour, logo affixed to the box or the product, any manuals that accompany the product, options for accessories, such as cables, battery chargers, replacement batteries, etc. for a phone product.

The preferred embodiment of the present invention utilises a Configurator and a software image generator (hereinafter referred to as “image generator”).

Known Configurators/image generators do not have intelligent software representations of components, as they use rule-based and/or simple hardware/mechanical component blocks. Notably, this is in contrast to the Configurator and image generator arrangement described below.

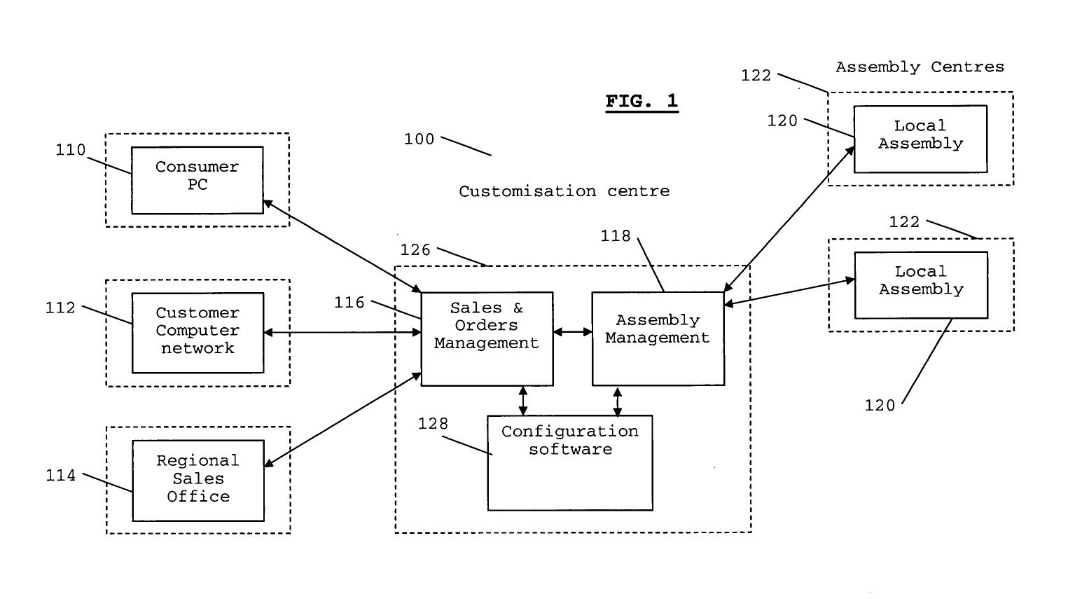

FIG. 1 illustrates an example of a mobile phone product design/build system 100 adapted to support the inventive concept of the preferred embodiments of the present invention. It is within the contemplation of the present invention that the mobile phone “product” includes the actual handset, its associated hardware and software elements, the container (box), its contents (manuals, chargers, etc.).

As illustrated in FIG. 1, the design/build system 100 of the preferred embodiment comprises a plurality of mechanisms where orders for electronic products may be constructed, received, processed and complete electronic products built in response thereto. For example, a consumer (i.e. an end user) 110 may access a customisation centre 126 via his/her personal computer (PC). Alternatively, a customer (i.e. an Operator) 112 may access the customisation centre 126 via their computer network. A yet further envisaged alternative is that one or more sales offices 114 may be located at different geographic locations and configured to access the customisation centre 126 via their computer network.

It is envisaged that the customisation centre 126 comprises a web-based mechanism for facilitating the construction of a device, receiving and processing orders for those constructed devices from customers and/or consumers. As such, a sales and orders management system 116 may specifically be implemented as suitable software running on suitable general purpose personal computers (PCs) to process the orders. The sales and orders management system 116 preferably also comprises an authentication function (not shown) to authenticate valid orders to be placed, thereby enabling customers and/or consumers to access the software build software architecture, as described later.

In the preferred embodiment of FIG. 1, the customisation centre 126 further comprises an assembly management system 118 coupled to the sales and orders management system 116. The assembly management system 118 may also be implemented as suitable software running on a suitable general purpose PC and may specifically be implemented in the same PC as the sales and orders management system 114. The assembly management components will dynamically alter the options presented to the user, to ensure that specific customers are presented with correct hardware and software configurations for their location, organisation and local legal requirements.

In the illustrated embodiment, the assembly management system 118 is coupled to a plurality of remote local assembly systems 120 situated in local assembly centres 122. The local assembly systems 120 typically comprise one or more manufacturing or assembly machines or units operable to assemble at least parts of a product, and preferably download software building blocks into phones that are selected by a customer or consumer, as represented by configuration software block 128.

The inventive concept of the present invention proposes to extend a phone configuration process using building blocks in a software domain. In this regard, software components of a mobile phone are isolated and encapsulated into building blocks. If new software options are required they are represented as new embedded software building blocks or derived from existing building blocks. A user (consumer or customer or customisation staff) is then provided with the opportunity to effectively “click” together a working phone from embedded software elements, such as an Operating system (OS) and/or one or more applications and/or one or more settings and/or one or more resources, as well as incorporate one or more hardware (including mechanical) components to build a phone. This ability is supported by the configuration software 128 located in the customisation centre 126.

One example, of many envisaged examples, for the dynamic customisation (or modification/upgrade) of a software-based electronic build is the opportunity for a sales outlet to offer customisation of the products that they sell. For example, it is envisaged that a software-based electronic product, such as a phone, may be configured with an application programming interface (API), to allow a user to customise their phone ahead of placing an order or purchasing a phone that can be ‘put together’ on site. In this regard, the API may allow a user to download a bitmap from a photograph to be used as a ‘splash screen’ or ‘idle/home screen’ on any phone that they purchase. Alternatively, the user may want to download a new game or a de-bugged/upgraded feature for a game. A yet further alternative may encompass downloading a language software ‘pack’ for a particular country, ahead of emigrating or going on holiday.

The system is configured (for example by means of links to the Enterprise Resource Planning (ERP) system) to be able to dynamically determine the price and availability of both hardware and software components, and dynamically display the unit cost (and/or margin) to the user.

The system of software blocks comprises a Configurator, preferably comprising a graphical user interface (GUI), which is modified to create, for example, a configuration “definition” file. An example of a suitable Configurator module is an enterprise Resource Planning system, as described at http://www.sap.com. In the Configurator, the software and hardware building blocks are preferably represented in object oriented fashion. The complete configuration solution preferably crosses several levels:
(i) Electronic Customer Configuration Checklist (e-CCL)-Configurator (comprising a graphical user interface (GUI));
(ii) Components/feature database (comprising the virtualised model of the devices and their hardware and software components);
(iii) The build environment, which in the preferred embodiment of the present invention is an image generator;
(iv) ERP translator: where the system is able to determine pricing and availability of components; and preferably
(v) A Configuration System (hereinafter referred to as a Sendo™ Configuration Administration System (SCAS)).

In order to keep the complete solution manageable a common building block representation is defined across all these systems.

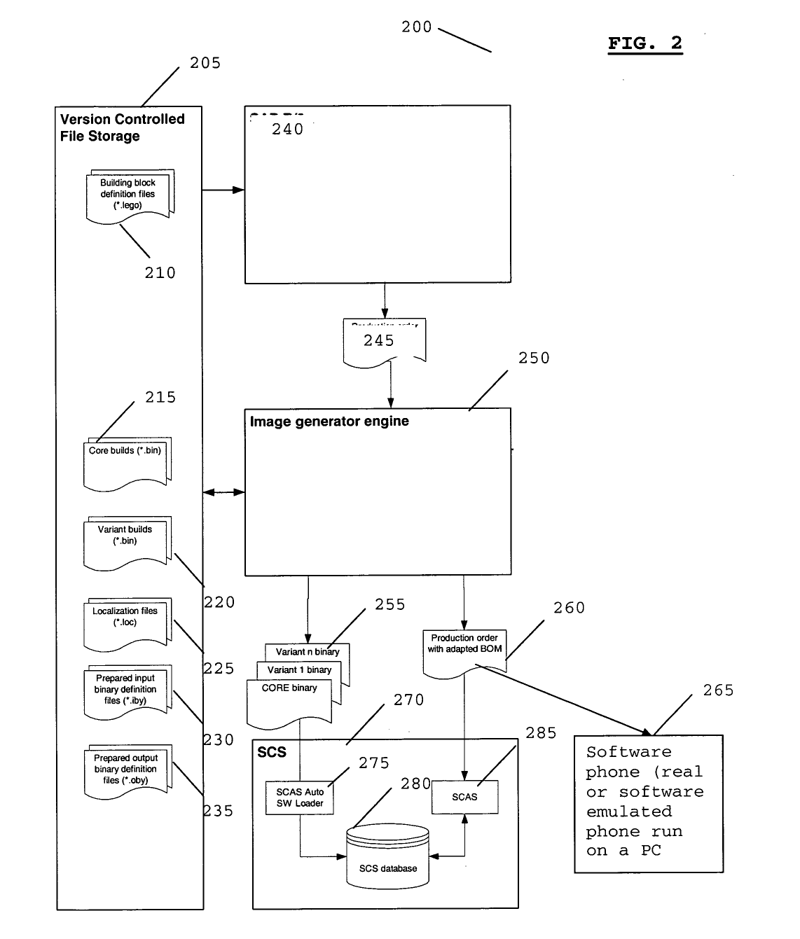

Referring now to FIG. 2, a preferred system architecture 200 is illustrated to control the complete configuration process for, say the build of a Smartphone. The preferred system architecture 200 comprises a version-controlled file storage function 205. The version-controlled file storage function 205 comprises the necessary software and hardware building blocks 210, comprising core building blocks 215, variant builds 220, localisation files 225 and binary definition files 230, 235. In the preferred embodiment of the present invention, the version-controlled file storage function 205 comprises, say, hundreds or thousands of software and/or hardware building blocks. Each block is also preferably provided with its own unique part number.

The version-controlled file storage function 205 is operably coupled to a Configurator 240 and an image generator engine 250. A customer or consumer preferably accesses a user interface, or GUI (not shown), of the Configurator 240. When ‘building’ a graphical representation of the electronic product, the Configurator 240 accesses representations of the embedded software and preferably hardware building blocks stored in the version-controlled file storage function 205.

The output of the Configurator 240 is preferably “definition” file 245. The definition file 245 of the device (that includes both hardware and software components) will preferably comprise all information regarding the device, at all levels. This file could, in theory, be regarded as the “recipe” for the construction of the device. The definition file 245 may take any suitable form, for example the definition file 245 may be in the form of a mark up language file, such as an adaptation of XML.

As the user has defined the device's requirements, including preferably its look and feel, it is possible to generate a set of scripts for use by a test (harness) engine (not shown), to ensure that the end product produced matches the specification of the user's chosen configuration.

In combination with the assembly database (validation), this dramatically reduces the requirements for test and delivery of a product to a customer.

The definition file 245 is passed from the Configurator 240 to the image generator engine 250. The image generator engine 250 uses the information contained within the definition file to generate a set of software image components to be loaded onto a device. These components are to be issued unique part numbers, and are included, along with the part numbers of all other components of the device, into a bill of material (BOM) 260.

The BOM 260 can then be passed to a configuration system 270, for example the assembly management system of FIG. 1, for actual construction on the assembly line.

In an enhanced embodiment of the present invention, it is envisaged that particular users, for example customers, consumers, customisation staff, sales outlet staff, etc., may be provided with different options in being able to select various components to form part of the build. For example, it is envisaged that a consumer may not be provided with the ability to select a frequency range and language profile for the phone. In this regard, the phone manufacturer may want to prevent the use of a particular software feature, say a game from use in a particular market. Thus, it is within the contemplation of the present invention that such a restriction may be in addition to any ‘incompatibility’ constraints imposed between particular product (phone) components.

The configuration system 270 comprises a configuration administrative system automatic software loader 275, for configuring the product with selected software elements, such as applications. The selected software code/applications are extracted from a configuration system database 280.

For the purpose of configuring a Smartphone build, it is envisaged that the image generator 250 may generate a production order with an adapted BOM 260. In an enhanced embodiment of the present invention, the adapted BOM may be used to emulate in software the operation of the Smartphone, for example, to be run on a real-life phone or on a PC 265. Again, the aforementioned test scripts can again be used to provide a test environment for the product at a virtual stage, before committing build resource.

Advantageously, with the provision of an emulator according to the enhanced embodiment of the present invention, the preferred solution may be iterative, i.e. a customer or consumer can assess the various selectable hardware and/or software options from the version-controlled file storage 205 and assess their impact in a real-life scenario, in a real-time manner, as more software elements are incorporated into the emulated phone. Thus, an iterative solution may be used to ensure consistency across various software/hardware versions.

This virtual device may also be presented during creation and configuration, so that a user can visualise and interact with a virtual representation of their product.

It is envisaged that the BOM may also comprise a list of parts, with new additional information relating to a particular product build. Preferably, the BOM may also comprise a favourite list of selectable hardware and/or software elements contained, say, in a browser.

A further advantage of the inventive concept hereinbefore described is that it is far easier for manufacturers and customers to collaborate on joint development work. In particular, the implementation is preferably web-based, to allow, for example, a Smartphone manufacturer to work with customers/vendors in an on-line manner.

In addition, it is envisaged that the aforementioned arrangement may be used as part of various project management exercises, in the development of products. That is, in this manner, a development or project engineer or manager is able to validate the inter-working of particular software and preferably hardware components more easily during a development phase of the product.

The Variant builds 215 preferably contain order/customer specific information and comprise the configurable software items for the Smartphone. Thus, the image generator 250 is used by the customer/consumer to combine software and preferably hardware building block representations, based on the core building blocks 215, and one or more variant builds 220, localisation files 225 and binary definition files 230, 235. Preferably, the image generator 250 also specifies what version of the build environment is to be used/being used.

The Configurator 240 provides an object representation of configurable elements in the build environment. As such, the Configurator 240 comprises software and preferably hardware representations of product elements, such as mobile phone elements. In an enhanced embodiment of the present invention, the software representation comprises embedded software elements, so that a mobile phone can be designed/built from these embedded software elements. Preferably, the embedded software elements are stand-alone items that may be configured within a phone in a ‘plug-in’ type manner.

It is envisaged that the software build can be performed over the Internet, through a client application or by another system or via a customer's system. Furthermore, it is envisaged that a new application can be added as an option on the Configurator 240, as a new isolated module (for example in the form of a Java bean) that describes both the application and its configuration relevant behaviour. In this form, the customer or consumer is able to manipulate the Configurator 240 elements, in effect by performing a drag and drop and verify operations. The build environment/image generator 250 is modified to deal with the application object, which preferably does not require extensions and/or modifications to many, if any, different parts of the build environment.

A hardware or software component object in the Configurator 240 should preferably be an object in the build environment. If the software component object cannot be the same as the object in the build environment, then the match should be as close as possible.

Example software candidate for representing these embedded software elements is C++ or JAVA. The classes of configurable elements are preferably equipped with a subset of the behaviour methods of matching Java beans in the Configurator 240, as will be appreciated by a skilled artisan. It is envisaged that a JAVA based arrangement provides the simplest and most efficient mechanism to implement a ‘drag and drop’ function within the Configurator 240.

In addition, it is envisaged that other advantageous methods may be supported using C++ classes, which are particularly applicable in a build environment. It is also envisaged that the classes in the build environment may comprise additional levels that are built into the software to handle more detail-specific builds.

A listing of various software configurable (selectable) elements, as used in the preferred embodiment of the present invention, comprises:
(i) Operator variant—Contains operator specific Bitmaps, splash screens, ring tones, etc.;
(ii) Operator Applications variant—Contains operator specific applications;
(iii) Language variant—Contains a set of languages with a specified default language; and
(iv) Specific applications, logos, bitmaps, splash screens, ring tones, etc.

Furthermore, it is envisaged that a listing of various hardware configurable elements, as used in the preferred embodiment of the present invention, comprises:
(i) Battery type;
(ii) Bezel; and
(iii) Labels.

A skilled artisan will appreciate that many other variant/selectable elements may be offered in alternative applications.

Downloading of binary files to a Smartphone build is preferably performed using a universal serial bus (USB), or by use of a removal memory module (such as a memory card), which is used for conventional programming of mobile phones.

In accordance with a preferred embodiment of the present invention, an input for the Configurator 240 is preferably a Customisation Checklist, as completed by the customer or consumer. Customisation of a Smartphone, as specified by the customer or consumer, may require changes to a configuration, depending upon, say, a rules database (not shown) for the Configurator 240. For instance, the consumer or customer may be provided with the opportunity to specify a combination of two applications where the rules database specifies that these applications typically cannot be used together, for example due to incompatibilities between the two applications. This means that the customer will have to change his/her requirements.

The preferred embodiment of the present invention envisages that the Operator is provided with the ability to specify several ‘application’ items of the user interface of the Smartphone, which are preferably configured/arranged to be customisable, by the end user. These items comprise:
(i) Background bitmaps;
(ii) Colour schemes;
(iii) Sounds;
(iv) Animations;
(v) Fonts; and
(vi) Indicators such as Key-lock, GPS signal, etc.

The Operator is preferably also provided with an opportunity to specify his/her own splash screen, i.e. the initial screen that appears for a few seconds following start-up, as well as specify how long the splash screen is to be displayed. In addition, the Operator is preferably also provided with an opportunity to specify one or more Operator-specific ring tones to be loaded into the phone.

It is envisaged that the Operator is preferably also provided with an opportunity to specify items that are specific for use in a particular country or region, in relation to the manufacture/build of a particular order. For example, the Operator may specify:
(i) One or more languages, where the number of specified languages is limited by the amount of memory used by the total build;
(ii) A default language, if more than one language is specified. Advantageously, this allows the Operator to order a single phone capable of operating in two different countries, where the phone starts up with the default language for the correct country in which the phone was sold; and
(iii) Default regional settings to control, for example, a display of date and/or time in the correct format for the specified region, and/or a display of currency/numbers, etc. in a correct format for the specified region and/or a default time zone, etc.

It is also envisaged that the Operator is provided with the opportunity to define the connection settings for each phone from, say, a list of connection types that are supported by the phone, to match the Operator's setup. Such connection settings may include one or more of the following:
(i) Wireless Access Protocol (WAP) parameters, where all WAP connection settings are specified in the WAP provisioning Content Specification, available from the WAP Forum (http://www.wapforum.org);
(ii) General Packet Radio System (GPRS) parameters;
(iii) Dial-up settings and parameters;
(iv) Browser settings, including browser favourites.

Here, the Operator is preferably provided with the opportunity to define a list of browser favourites to be pre-configured in the phone for a particular order. The definition of a browser favourite will preferably include at least a descriptive tag and the URL. Additionally, the Operator is preferably able to specify a sequence in which the Browser favourites appear;
(v) Proxy settings and parameters; and
(vi) Over-the-air programming (OTAP) mechanisms.

In an enhanced embodiment of the present invention, it is envisaged that the Image Generator build engine may be expanded with a Graphical User Interface (GUI). This GUI is preferably configured to allow the Operator to enter the information from the Customisation checklist. The GUI application then outputs a BOM, limited to only the build specific information. In this manner, the Image Generator set-up can be used and tested before the Configurator is put in place.

Advantageously, the aforementioned build mechanism enables the phone binaries to be built by someone who is not technically proficient, thereby enabling orders for the phone to be fulfilled in a customisable manner.

Thus, an image may be generated in a post manufacturing process step in a distribution/retail context using a plurality of selectable software representation blocks

In addition, it is possible for customer specific components to be incorporated, without the need for the customer to manually specify them. For example, in the above example, the resource files of the product may include customer specific graphics and logos. Such logos have preferably been previously arranged and agreed with the customer, for example from previous orders and/or negotiations.

In this manner, the order information may comprise a customer identifier for a particular software-package option. Thus, the part number for the software-package option may be specific to Customer ‘X’.

As previously mentioned, the order for an electronic product, particularly when placed by a customer such as an Operator, may encompass a large number of products. Sets of these products may be configured in substantially the same manner or some may be configured with individual requirements.

It is within the contemplation of the invention that the inventive concepts hereinbefore described are not limited to the described Smartphone software build or associated manufacturing system of the preferred embodiment. Indeed, it is envisaged that the inventive concepts are applicable to any suitable mass-produced software-based electronic product (or product that offers software variants) comprising embedded software and preferably hardware elements.

It will be understood that the electronic product build system, as described above, tends to provide one or more of the following advantages:
(i) Ability for a customer or a consumer to ‘build’ individual (or groups of) phones ‘on-the-fly’ using software building blocks;
(ii) Ability to use software building blocks in a Lego™ kit fashion, using a template of previous ‘build processes’, for example new configurations may be based on old configurations;
(iii) Provides scalable and extensible build architecture using software and preferably hardware configurable elements;
(iv) The electronic product is configurable over a suitable communication medium, such as the Internet;
(v) By configuring the software building blocks in an isolated and encapsulated manner, the dynamic approach to building an individual phone or group of phones can be readily implemented, for example the build of a phone may be used to simulate real-life behaviour of the phone;
(vi) Software upgrades can be derived from existing software building blocks or prepared from new;
(vii) The configuration process can be performed by un-skilled/un-trained personnel; and
(viii) The system is particularly suited for an automatic or semi-automatic manufacturing process, thereby obviating or reducing the requirements for manual intervention. This process reduces employee costs, reduces repair costs and increases yield.

Whilst the specific and preferred implementations of the embodiments of the present invention are described above, it is clear that one skilled in the art could readily apply variations and modifications of such inventive concepts.

Thus, an improved electronic product build system and method therefor has been described where at least one of the aforementioned disadvantages with prior art arrangements has been alleviated.

1. A method of customising a build of an electronic software-based product comprising the step of:
representing in a software programme a plurality of embedded software elements;
the method characterised by the steps of:
generating one or more software images that represents a plurality of the embedded software elements; and
building an electronic software-based product based on the generated images.

2. A method of customising a build of a software-based electronic product according to claim 1 wherein the step of representing the plurality of embedded software elements comprises representing additionally at least one of from the group comprising:
(i) a hardware element; and
(ii) a packaging element; and
(iii) an accessory.

3. A method of customising a build of a software-based electronic product according to claim 1 wherein the step of generating one or more software images comprises configuring an image representation such that the product can be generated by an end user or device distributor.

4. A method of customising a build of a software-based electronic product according to claim 1 wherein the step of generating an image is performed in a post manufacturing process step in a distribution/retail context using a plurality of selectable software representation blocks.

5. A method of customising a build of a software-based electronic product according to claim 1, wherein the step of representing a plurality of embedded elements is performed in a remote location relative to the step of generating a programme image.

6. A method of customising a build of a software-based electronic product according to claim 1 wherein the software-based electronic product is a mobile phone.

7. A method of customising a build of a software-based electronic product according to claim 1 wherein the step of simulating an operation of the software-based electronic product, thereby facilitating an iterative approach to validating inter-operability between a plurality of embedded software elements.

8. A method of customising a build of a software-based electronic product according to claim 1 wherein in the step of issuing a unique part number to each software image generated, said part number is included in a customised bill of material (BOM) for the software-based electronic product.

9. A method of customising a build of a software-based electronic product according to claim 1, wherein the step of creating a definition file, the definition file being used in the generation of the one or more software images.

10. A method of customising a build of a software-based electronic product according to claim 1, wherein one or more of the embedded software elements comprise one or more of the following:
(i) an Operating System;
(ii) an application;
(iii) a setting; and
(iv) a resource.

11. A method of customising a build of a software-based electronic product according to claim 10, wherein the embedded software elements are individual and distinct elements encapsulated into software building blocks.

12. A method of customising a build of a software-based electronic product according to claim 10 wherein the step of representing comprises representing software elements in such a manner that an anticipated behaviour of at least one embedded software element when provided in a final product is mimicked in software.

13. A method of customising a build of a software-based electronic product according to claim 10, wherein the embedded software elements comprise one or more of the following:
(i) Operator specific Bitmaps,
(ii) One or more splash screens;
(iii) One or more ring tones;
(iv) One or more Logos;
(iv) Operator specific applications;
(v) Locale variant information, such as a set of languages or a specified default language;
(vi) One or more specific applications,
(vii) One or more colour schemes;
(viii) One or more Sound;
(ix) One or more animations;
(x) One or more fonts;
(xi) A default regional setting;
(xii) A connection setting;
(xiii) One or more graphics; and
(xiv) One or more indicators, such as Key-lock, GPRS signal.

14. A software-based electronic product build system comprising:
a configurator module arranged to represent in software a plurality of selectable embedded software elements; and
an image generator operably coupled to the configurator module;
herein the software-based product build system is characterised in that the image generator generates one or more software images representing at least one embedded software element; and the software-based electronic product build system is configured to build a software-based electronic product based on a plurality of embedded software elements using the generated software image(s).

15. A software-based electronic product build system according to claim 14 wherein the configurator module is arranged to represent in software at least one embedded software element and additionally at least one:
(i) Hardware element; and/or
(ii) Packaging element; and/or
(iii) Accessory.

16. A software-based electronic product build system according to claim 14 wherein the software-based electronic product build system is accessible by a customer or consumer for the customer or consumer to generate a build of the software-based electronic product based on a selection from a plurality of embedded software elements.

17. A software-based electronic product build system according to claim 14 wherein the configurator module comprises a graphical user interface (GUI).

18. A software-based electronic product build system according to claim 14 wherein a version-controlled file storage function operably coupled to the configurator module and image generator and comprising embedded software and hardware building blocks, core building blocks variant builds, locale variant files and/or binary data files.

19. A software-based electronic product build system according to claim 16 wherein the Configurator outputs a definition file with extended information to serve as an input for the Image Generator.

20. A software-based electronic product build system according to claim 18 wherein the Image Generator is an application that takes information from the definition file, and/or from the Version Controlled File Storage to generate Core and Variant builds of the product.
